(19) United States
(12) Patent Application Publication
(10) Pub. No.: US 2022/0333597 A1
(43) Pub. Date: Oct. 20, 2022

(54) INTEGRATED SCREW-SPINDLE COOLANT PUMP

(71) Applicant: NIDEC GPM GMBH, Auengrund OT Merbelsrod (DE)

(72) Inventor: Franz Pawellek, Lautertal (DE)

(21) Appl. No.: 17/615,963

(22) PCT Filed: Jun. 23, 2020
(86) PCT No.: PCT/EP2020/067429

§ 371 Date: Dec. 2, 2021

(30) Foreign Application Priority Data
Jul. 4, 2019 (DE) 10 2019 118 086.4

(51) Int. Cl. F04C 14/00; F04C 11/00; F04C 2/16; F04C 15/00; F01P 5/12

(52) U.S. Cl. CPC F04C 14/00; F04C 11/008; F04C 2/16; F04C 15/0007; F04C 15/0096; F01P 5/12; F04C 2240/40; F04C 2240/50; F04C 2240/803; B60K 2001/005

(57) ABSTRACT

An electric screw coolant pump for integration into a temperature control circuit of an assembly of which the temperature is to be controlled. An accommodation housing includes a feeder line and a return line of the temperature control circuit, which open into a cavity. A part of the cavity surrounds a spindle housing and communicates with an outlet opening of the spindle housing as well as the feeder line. A sealing element, which provides a seal between a suction side and a pressure side, is arranged towards an end surface of the axial end of the inserted spindle housing.

### CROSS-REFERENCE TO RELATED APPLICATIONS

This application is a U.S. National Phase of International Application No PCT/EP2020/067429, filed on Jun. 23, 2020, which claims priority to DE 10 2019 118 086.4 filed on Jul. 4, 2019, all of which are hereby incorporated by reference herein for all purposes.

### FIELD

The present invention relates to an electric screw coolant pump with an integral construction for integration into a temperature control circuit. Furthermore, a temperature control device for an assembly of which the temperature is to be controlled is proposed, into the temperature control circuit of which the electric screw coolant pump is integrated.

### BACKGROUND

Screw pumps comprise a robust rotary piston mechanism which is not sensitive to soiling and which operates without delicate elements such as stop valves or the like. A volumetric adjustment with respect to a preset rotational speed is not possible. Mechanically driven screw pumps are predominantly known from use in large-scale applications such as e.g., oil pumps in stationary installations or ships engines in which they run with relatively constant operating points.

The application documents DE 10 2005 025 816 A1 and EP 2 765 311 A2 disclose screw pumps with a multi-part housing.

In the area of fuel delivery pumps of vehicles, smaller electrically driven screw pumps have recently become known. The documents US 2018/0216614 A1, DE 10 2015 101 443 B3, WO 2014/138519 A1 and DE 10 2017 210 771 A1 describe such fuel delivery pumps, the wet-running electric motor of which is designed without a separating can and so both the rotor and the stator are in contact with the fuel. However, the known screw fuel pumps are not transferable to an application as an electric coolant pump, these being exposed to corrosive coolants.

The cooling circuits of battery-electric vehicles are highly complex, having a large number of line branches, fluid connections and various pumps and valves. Each node point or transition point of the line branches leads to increased outlay for assembly of lines and seals. For this purpose, each node point or transition point of the line branches requires an accessible installation space. In addition, a division of the passage cross-section of the whole cooling circuit into line branches with correspondingly small passage cross-sections requires a higher delivery pressure in the cooling circuit. There is therefore an increased risk of leakages or larger sealing failures. Owing to the aging of elastic components in lines and seals, each node point or transition point of the line branches also leads to increased maintenance costs.

Accordingly, the development of battery-electric vehicles has included attempting to achieve an integrated construction for the thermal management system, which operates with a reduced number of hose connections and fluid couplings. There is an economic consideration that alternative constructions of integrated line branches should not substantially exceed the costs for conventional node points or transition points.

### SUMMARY

An object of the present invention is to avoid hose connections and fluid couplings.

The object is achieved in accordance with the invention by an electric screw coolant pump having the features of claim 1. The electric screw coolant pump is characterized in particular in that an accommodation housing comprises a feeder line and a return line of the temperature control circuit which open into a cavity; a part of the cavity surrounds a spindle housing and communicates with an outlet opening—of the spindle housing—and the return line; and a sealing element providing a seal between a suction side and a pressure side is arranged towards an end surface of an axial end of the spindle housing—which is inserted into the cavity.

The invention provides for the first time an insertable electric screw pump which forms an integrated construction with a temperature control circuit.

Therefore, an alternative interface at transitions between a pump and a circuit is produced, whereby conventional components such as hose connections or fluid couplings are omitted.

The design in accordance with the invention of the integral construction can also be mass produced economically, in a manner optimized in terms of installation space, in a modular fashion and without sensitivity to manufacturing tolerances, as explained in detail below.

Internal conduits, such as a feeder line and return line of the circuit, or a cavity can be produced economically by manufacturing housing parts using a casting technique.

The cavity which surrounds the spindle housing is used as an outlet chamber of the pump. During construction of a housing, a degree of freedom of 360° is therefore available with respect to a radial arrangement of the return line to the pump. Therefore, an arrangement can be selected which is optimized to the smallest possible installation space in relation to system environment.

On one side, the pump has a pump head which can be inserted into a cavity and is in the shape of the spindle housing, and on the other side has a motor housing located outside the cavity. In spite of the integrated construction, use of electric motors with different dimensions is rendered possible.

Manufacturing tolerances can arise during the production of cast parts for a housing. Manufacturing tolerances can arise in particular when fits are formed between housing parts which are part of two assemblies with different functions or origins. In the case of post-machined fits or bores, radial dimensional stability is generally less critical than axial dimensional stability. In the case of the construction in accordance with the invention, the inlet and a sealing element are allocated at their end surface to the end of an inserted spindle housing. Therefore, an element which assumes the function of a seal for the pump is at the same time used to compensate for a manufacturing tolerance in the axial dimensions of the cavity of the accommodation housing and a manufacturing tolerance in the axial dimensions of the inserted spindle housing.

Furthermore, the seal between the suction side and pressure side of the pump is subject to a large difference in pressure. A sufficient sealing effect which can be adjusted by pressing the seal can be ensured with the aid of a tightening torque between the housing flange and the accommodation housing.

Said aspects contribute as a whole to an integrated construction which, compared to conventional interfaces between a pump and a circuit by means of hose connections or fluid couplings, ensures a higher level of operating reliability and longer service life.

The selection of an electric screw coolant pump provides a pump type with which higher delivery pressures can be achieved than with a centrifugal pump or radial impeller pump. In comparison to conventional coolant pumps, the pump type in accordance with the invention makes available a higher delivery pressure potential for cooling circuits or temperature control circuits with line branches and corresponding constrictions.

Furthermore, the screw coolant pump comprises a smaller acoustically effective surface with respect to the surrounding housing compared to conventional coolant pumps of the centrifugal pump type. The rotating movement of the blades of an impeller generate rotational speed-dependent pressure fluctuations at chamber walls of the pump chamber which may be in a resonant frequency range of housing parts. In contrast, the rotating movement of the screw spindles generates a more uniform delivery behavior, wherein only a small housing-side end surface is exposed to the screw spindles of a pressure-side pulsation. Consequently, the pump type in accordance with the invention ensures lower noise development, which is advantageous especially when the accommodation housing comprises a further cavity e.g., as an integral component of a further assembly in the temperature control circuit.

Advantageous developments of the invention are provided in the dependent claims.

According to one aspect of the invention, the return line can open into an end surface of the cavity, which is situated across from the end surface of the axial end of the inserted spindle housing. This arrangement contributes to achieving the shortest possible suction-side delivery path between the accommodation housing and the spindle housing.

According to one aspect of the invention, the sealing element can radially surround the mouth of the return line and the inlet opening of the spindle housing. This arrangement contributes to achieving the smallest possible sealing surface between the suction side and the pressure side of the pump.

According to one aspect of the invention, the accommodation housing can be integrally formed at a housing of the assembly of which the temperature is controlled by the temperature control circuit. This formation provides a further constructional integration between a pump-side housing and a housing part of a module attached thereafter in the temperature control circuit. Therefore, further node points or connection points at an interface between a feed and return of the temperature control circuit and the assembly of which the temperature is to be controlled by means of hose connections or fluid couplings can be dispensed with and a corresponding installation space for this purpose can be dispensed with.

According to one aspect of the invention, the screw spindles can be mounted in a floating manner inside the spindle housing by means of a clearance fit. In the case of coolant pumps of the centrifugal pump type, an axial gap between an impeller and the pump chamber constitutes the greatest weak point with respect to sealing between the suction side and the pressure side of the pump. Leakage at the axial gap and a corresponding loss of delivery performance increase at higher delivery pressures. The adjustment of a sealing-effective gap dimension depends on the dimensional stability of an axial fit between the impeller and the housing after assembly. In the case of a screw pump, the effective sealing gap between the suction side and the pressure side extends over the whole length of the screw spindles. By the formation of a clearance fit, the floatingly mounted screw spindles are pressed on the suction side against a housing-side run-up surface. In this way, an effective axial sealing gap against leakage between the end surfaces of the screw spindles and the area of the inlet in the spindle housing is automatically produced. The axial sealing gap is formed irrespective of manufacturing tolerances. It is not necessary to maintain an axial gap dimension at the opposing end of the screw spindles.

According to one aspect of the invention, a screw spindle and a shaft of the electric motor can be connected with a clearance fit by means of a plug-in connector. By the use of a plug-in connector which at least allows axial clearance, the clearance fit for the floating mounting of the driven screw spindle is impaired as little as possible. Furthermore, an interface for the coupling of a shaft of different electric motors is produced and renders possible a modular drive concept.

According to one aspect of the invention, the spindle housing can be delimited in the area of the inlet opening by a feather key inserted through a radial assembly gap. The mounting and insertion of the screw spindles is simplified by formation of a feather key which can be formed in a simplified manner as a bearing shield with an inlet opening.

According to one aspect of the invention, the sealing element can radially surround an axial area of the axial end of the spindle housing and seal the radial assembly gap of the feather key. In this case, the sealing element assumes a sealing function at a further opening. Low assembly costs are ensured by the use of a sealing element for the inlet opening and the assembly slot.

According to one aspect of the invention, a sealing ring providing a seal between the pressure side and an external environment can be arranged in a radial clearance between the spindle housing and the accommodation housing. The sealing of the pressure side to the outside is subject to a lower pressure difference than that between the suction side and the pressure side. A pressing and sealing effect of the sealing ring can be ensured easily and sufficiently by means of the radial dimensional stability of the housing parts. As explained above, the radial dimensional stability is less critical in terms of processing technology than the axial dimensional stability. Therefore, once again, low assembly costs are ensured.

According to one aspect of the invention, the housing flange can have a bearing seat for a shaft bearing. This formation renders possible the use of a single shaft bearing and contributes to achieving compact axial dimensions for the pump.

According to one aspect of the invention, the shaft bearing can be a sliding bearing bushing surrounded by a sealed lubricant filling. This formation makes it possible for the bearing of the shaft to be compact and long-lasting. The sealed lubrication of the bearing resists any washing out or settling of the coolant. In contrast to oil-based media to be delivered, such a lubrication oils or fuels, the contact between the sliding bearing and a coolant can have detrimental effect on the sliding properties of the shaft bearing.

According to one aspect of the invention, power electronics can be arranged inside the motor housing in thermal contact with the housing flange. The housing flange is in contact and in a heat-exchange relationship with the accommodation housing through which the coolant of the temperature control circuit flows. The arrangement of the power electronics in thermal contact with the housing flange provides an effective structure for diverting waste heat from the power electronics.

### BRIEF DESCRIPTION OF THE DRAWINGS

The invention will be explained hereinafter with the aid of an embodiment and with reference to the accompanying drawing,

FIG. 1 shows a schematic sectional view through a screw coolant pump according to one embodiment of the invention.

### DETAILED DESCRIPTION

The term “temperature control circuit” in the sense of this disclosure is to be understood to mean a delivery circuit for a coolant which is brought into thermal contact with an assembly in order to absorb waste heat of the assembly and to output it to a cooler medium such as e.g., the atmosphere. However, the manner of operation of the temperature control circuit is not limited to a cooling function. Thus, the temperature control circuit can also provide a warming function by means of a heat source during a start-up phase of the assembly of which the temperature is to be controlled.

The terms “feeder line” and “return line” of the temperature control circuit relate to how the assembly of which the temperature is to be controlled is viewed. Consequently, the feeder line of the temperature control circuit is connected to the outlet opening of the pump and the return line of the temperature control circuit is connected to the inlet opening of the pump.

In a temperature control circuit, a plurality of assemblies of which the temperature is to be controlled and which have the same or different functions can be incorporated into a plurality of modules which have a flow passing through them in succession or in parallel. Furthermore, a temperature control circuit can comprise a plurality of pumps.

The term “accommodation housing” relates, in the sense of this disclosure, to a housing body which is formed as a housing component or as an integral housing portion of a housing and which constitutes a component of the housing structure of the pump or of the assembly of which the temperature is to be controlled.

In terms of this disclosure, the term “screw pump” is understood to mean skew rotary piston pumps with a thread pitch for displacement of the medium to be delivered. Such types of pumps generally comprise a driven screw spindle and at least one further screw spindle which is in coupled motion therewith via engagement of the toothing.

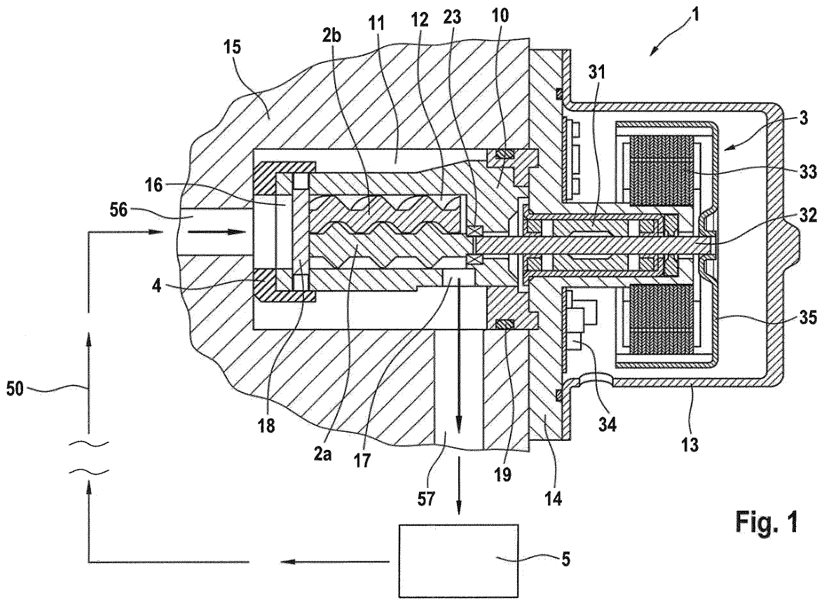

The electric screw coolant pump 1 which is shown in FIG. 1 is arranged in an integrated manner within a temperature control circuit 50. The temperature control circuit 50 serves to control the temperature of an assembly 5 such as e.g., to discharge waste heat from the operation of the assembly 5 by means of a coolant delivered by the screw pump 1. In the following application, the assembly 5, not shown in more detail, is a traction battery for a battery-electric vehicle. Such a temperature control circuit 50 comprises a plurality of channels with a small cross-section which are in thermal contact with a plurality of battery cells.

In the embodiment of the schematic illustration of FIG. 1, in a spindle housing 10, a driven screw spindle 2a and a screw spindle 2b in coupled motion are received in a rotatable manner in a spindle chamber 12 of the spindle housing 10. A cross-sectional contour of the spindle chamber 12 is formed by two bores in the spindle housing 10, with overlapping radii, in order to ensure engagement of the screw spindles 2a, 2b. An open side of the spindle chamber 12 is delimited by a feather key 18. The feather key 18 is formed flat as an end-surface chamber wall of the spindle chamber 12 and has an inlet opening 16 of the spindle housing 10. The feather key 18 is inserted into the spindle housing 10 through a mounting slot perpendicularly to the screw spindles 2a, 2b.

The screw spindles 2a, 2b are mounted in a floating manner by a radial clearance fit with respect to the cross-sectional contour of the spindle chamber 12 and by an axial clearance fit of the spindle chamber 12. During pump operation, the spindles are pressed against the feather key 18 by the displacement process. The feather key 18 serves as a bearing shield with respect to the axial sliding bearing of the end surfaces of the screw spindles 2a, 2b.

A pressure side of the spindle chamber 12, which communicates with an outlet opening 17 of the spindle housing 10, is located on the drive side of the screw spindles 2a, 2b, which is depicted on the right. A suction side of the spindle chamber 12 is located on the other side of the screw spindles 2a, 2b on which the feather key 18 is disposed. The suction side of the spindle chamber 12 communicates with the inlet opening 17 of the spindle housing 10.

The spindle housing 10 forms, with the screw spindles 2a, 2b, an insertable pump head which is inserted into an accommodation housing 15 from an axial end of the spindle housing 10, towards which the inlet opening 16 is directed, up to a housing flange 14 which is connected to the opposing axial end of the spindle housing 10. The accommodation housing 15 is a component of the screw pump 1 and of the temperature control circuit 50. The accommodation housing 15 can at the same time be an integral component of the assembly 5 of which the temperature is to be controlled, such as e.g., a module housing of the assembly 5 in which the temperature control circuit 50 is continued in the form of integrated channels.

The accommodation housing 15 comprises an opened cavity 11 which receives the spindle housing 10 up to the housing flange 14. A return line 56 and a feeder line 57 of the temperature control circuit 50 open into the cavity 11. The feeder line 57 opens into a peripheral surface of the cavity 11. The cavity 11 surrounds the spindle housing 10 in such a way than an annular part of the cavity 11 is exposed where it overlaps with the outlet opening 17 and the mouth of the feeder line 57. FIG. 1 illustrates the outlet opening 17 and a mouth of the feeder line 57 directed downwards and orientated towards each other. In a deviation therefrom, both the outlet opening 17 and the mouth of the feeder line 57 can be orientated towards each other at any angles. The exposed part of the cavity 11 produces a pressure-side connection between the spindle housing 10 and the temperature control circuit 50.

The return line 56 opens into an end-face base surface of the opened cavity 11 and is allocated, in an opposing arrangement, to the inlet mouth 16 at the axial end of the inserted spindle housing 10. A sealing element 4 surrounds the mouth of the return line 56 and the inlet mouth 16 so that a suction-side connection is produced between the temperature control circuit 50 and the spindle housing 10.

The sealing element 4 also constitutes the housing-side seal between the suction side and the pressure side of the screw pump 1. During assembly of the screw pump 1, the sealing element 4 is pressed in, in a sealingly effective manner, by a tightening torque of the housing flange 14 against the accommodation housing 15 and compensates for axial manufacturing tolerances between the spindle housing 10 and the cavity 11. The sealing element 4 further surrounds a periphery of the spindle housing 10 in the area of the assembly slot, through which the feather key 18 is introduced. Therefore, a possible leakage flow along a plug-in fit of the feather key 18 is sealed. In the exposed cavity 11, a sealing ring 19 is introduced into groove-like radial free space upstream of the housing flange 14 in order to seal the pressure side of the screw pump 1 to the outside.

The driven screw spindle 2a is connected to an electric motor 3. On the pressure side of the spindle chamber 12, the spindle housing 10 comprises an aperture for a shaft 32 which is driven by the electric motor 3. A motor housing 13, in which the electric motor 3 is arranged, is connected on the opposing side of the housing flange 14. An internal stator 33 of the electric motor 3 is located on a collar portion of the housing flange 14. An external pot-shaped rotor 35 surrounds the stator 33 and is connected to one end of the shaft 32. A bearing seat for a shaft bearing 31 is formed internally on the collar portion of the housing flange 14. The shaft bearing 31 is a sliding bearing which is sealed at both axial ends and is filled with a lubricant. The other end of the shaft 32 is coupled to the driven screw spindle 2a by means of a plug-in connector 23 which allows axial clearance.

The motor housing 13 comprises a separated motor chamber, in which the dry-running electric motor 3 and an electronic system, in particular power electronics 34 for switching the electric power at the electric motor 3, are received. The stator 33 comprises field coils which are actuated by the power electronics 34 and supplied with electric power. The stator 33 is in thermal contact with the peripheral surface of the collar portion of the housing flange 14. Thus, waste heat from the field coils of the stator 33 is diverted via the housing flange 14 to the accommodation housing 15 and the spindle housing 10 and is absorbed by the temperature control circuit passing therethrough. The power electronics 34 are likewise arranged in thermal contact with the end surface of the housing flange 14 in order to discharge waste heat from the electronic components into an area of the temperature control circuit through which a flow passes.

The screw pump 1 is considered hereunder in a delivery direction of the temperature control circuit 50 in order to control the temperature of an assembly 5. A liquid delivery medium or a coolant is sucked into the spindle chamber 12 from the return line 56 of the temperature control circuit 50 through the seal 4 and the inlet opening 16 of the spindle housing 10 on the suction side. A rotational movement of engaged screw profiles of the rotating screw spindles 2a, 2b generates a negative pressure on the suction side of the spindle chamber 12 and a positive pressure on the opposing pressure side of the spindle chamber 12. The coolant is delivered by continuous displacement along a screw pitch of the engaged screw profiles and ejected from the spindle chamber 12 through the outlet opening 17 of the spindle housing 10. Downstream of the outlet opening 17 the coolant flows via the cavity 11 into the feeder line 57 of the temperature control circuit 50 and to the assembly 5.

### LIST OF REFERENCE NUMERALS

1 Screw pump
2a Driven screw spindle
2b Screw spindle in coupled motion
3 Electric motor
4 Seal
5 Assembly of which the temperature is to be controlled
10 Spindle housing
11 Cavity
12 Spindle chamber
13 Motor housing
14 Housing flange
15 Accommodation housing
16 Inlet opening of the spindle housing
17 Outlet opening of the spindle housing
18 Feather key
19 Sealing ring
23 Plug-in connector
31 Shaft bearing
32 Shaft
33 Stator
34 Power electronics
35 Rotor
50 Temperature control circuit
56 Return line of the temperature control circuit
57 Feeder line of the temperature control circuit

1. An electric screw coolant pump for integration into a temperature control circuit of an assembly of which a temperature is to be controlled, comprising:
a motor housing in which an electric motor is accommodated,
a spindle housing, in which screw spindles are accommodated, with an axial inlet opening and a radial outlet opening;
a housing flange connecting the motor housing and the spindle housing,
an accommodation housing with an opened cavity into which the spindle housing is insertable from an axial end up to the housing flange;
wherein the accommodation housing includes a feeder line as well as a return line of the temperature control circuit which open into the cavity; a part of the cavity surrounds the spindle housing and communicates with the outlet opening as well as the feeder line; and a sealing element providing a seal between a suction side and a pressure side is arranged towards an end surface of the axial end of the inserted spindle housing.

2. The electric screw coolant pump according to claim 1, wherein the return line opens in an end surface of the cavity situated across from the end surface of the axial end of the inserted spindle housing.

3. The electric screw coolant pump according to claim 1, wherein the sealing element radially surrounds a mouth of the return line and the inlet opening of the spindle housing.

4. The electric screw coolant pump according to claim 1, wherein the accommodation housing is integrally formed at a housing of the assembly of which the temperature is controlled by the temperature control circuit.

5. The electric screw coolant pump according to claim 1, wherein the screw spindles are mounted in a floating manner inside the spindle housing by means of a clearance fit.

6. The electric screw coolant pump according to claim 1, wherein one of the screw spindles and a shaft of the electric motor are connected by means of a plug-in connector with a clearance fit.

7. The electric screw coolant pump according to claim 1, wherein the spindle housing is delimited in an area of the inlet opening by a feather key inserted through a radial assembly gap.

8. The electric screw coolant pump according to claim 7, wherein the sealing element radially surrounds an axial area of the axial end of the spindle housing and seals the radial assembly gap of the feather key.

9. The electric screw coolant pump according to claim 1, wherein a sealing ring providing a seal between the pressure side and an external environment is arranged in a radial clearance between the spindle housing and the accommodation housing.

10. The electric screw coolant pump according to claim 1, wherein the housing flange has a bearing seat for a shaft bearing.

11. The electric screw coolant pump according to claim 10, wherein the shaft bearing is a sliding bearing bushing surrounded by a sealed lubricant filling.

12. The electric screw coolant pump according to claim 1, wherein power electronics are arranged inside the motor housing in thermal contact with the housing flange.

13. A temperature control device for controlling a temperature of an assembly comprising:
an accommodation housing in which the assembly is accommodated;
a temperature control circuit that is formed in the accommodation housing and which is in thermal contact with the assembly;
the electric screw coolant pump according to claim 1 integrated into the temperature control circuit,
wherein the accommodation housing is integrally formed as one common element of the temperature control device and the electric screw coolant pump.

14. The temperature control device for controlling the temperature of the assembly according to claim 13, wherein the assembly is a battery storage module having a multitude of battery cells.
